(19) United States
(12) Patent Application Publication
(10) Pub. No.: US 2017/0017921 A1
(43) Pub. Date: Jan. 19, 2017

(54) LOCATION INFORMATION VALIDATION TECHNIQUES

(71) Applicant: BANDWIDTH.COM, INC., Raleigh, NC (US)

(72) Inventor: LARRY REEDER, DENVER, CO (US)

(73) Assignee: BANDWIDTH.COM, INC., RALEIGH, NC (US)

(21) Appl. No.: 14/800,963

(22) Filed: Jul. 16, 2015

(51) Int. Cl. G06Q 10/08; G06Q 50/32

(52) U.S. Cl. CPC G06Q 10/0838; G06Q 50/32

(57) ABSTRACT

Embodiments of the present invention relate generally to methods and systems for validating location information and more particularly to validating an address associated with a communication identifier such as a telephone number which can be used, for example, to handle an emergency call placed from that telephone number. Generally speaking, embodiments of the present invention can include a validation process for location information received during registration of a subscriber of a communication service. The registration information can comprise a telephone number and an address. In one example, the received address can comprise a United States Postal Service (USPS) standard address while the validated address can comprise a Master Street Address Guide (MSAG) valid address.

### BACKGROUND OF THE INVENTION

Embodiments of the present invention relate generally to methods and systems for validating location information and more particularly to validating an address associated with a communication identifier such as a telephone number which can be used, for example, to handle an emergency call placed from that telephone number.

Voice Service Providers (VSPs) can provide communication services to properly registered or provisioned telephone numbers. This registration or provisioning involves, among other thing, associating location information, such as the subscriber's home address or other address, with the telephone number. When a caller places an emergency call from a provisioned telephone number, a Public Safety Answering Point (PSAP) handling the call will query the VSP's Automatic Location Identification (ALI) database in which the registered address of that telephone number is stored to find the address for the caller. The ALI address stored by the VSP must conform to the address ranges in the Master Street Address Guide (MSAG), which are usually formatted to the local standards of that emergency authority, and which can be different from the United States Postal Service (USPS) addressing standards. However, when VSP customers or subscribers provision an address, they use their postal address. The VSP system is then tasked with converting that postal address to a MSAG-valid address which can be delivered to the PSAP during an emergency call.

This conversion can problematic due to variations in the postal and MSAG record fields. One common difference is the postal city and the MSAG-valid city or “community.” For instance, in Pennsylvania, the emergency authority will often use the township the address is in for the community, rather than the city the address is in. In some other places, the housing community name is used instead of the postal city. Furthermore, there is no authority that provides a mapping from postal city to MSAG community.

There are two basic approaches to matching the postal city to MSAG community. In the first approach, the VSP will assume that the postal city and MSAG community are the same, standardize the city names and MSAG community by removing spaces, using common abbreviations, and applying upper-casing to the names, and then try to match the standardized MSAG community and postal city. In the second approach, the VSP can use a list of MSAG community “aliases” for each city name. An alias is an MSAG community known to be associated with addresses in the postal community. For example, East Lampeter Township is the MSAG community for some postal addresses in Lancaster, PA. For a given city in a provided subscriber address, the VSP can look at each alias in turn and use that alias to attempt to match the address against the MSAG data.

The first approach can fail because, as mentioned, sometimes the MSAG community is quite different from the postal city. The second approach requires research to associate the MSAG community alias with the city, and is less efficient computationally because it requires a new query for each alias associated with the postal city. When both approaches fail, the emergency address falls out of the MSAG validation process, and a human reviewer must be engaged to manually match the emergency address to its associated MSAG address. Hence, there is a need for improved methods and systems for the MSAG validation process, i.e., validating an address associated with a communication identifier such as a telephone number which can be used, for example, to handle an emergency call placed from that telephone number.

### BRIEF SUMMARY OF THE INVENTION

Embodiments of the present invention provide methods and systems for validating location information such as an address associated with a communication identifier, e.g., a telephone number. According to one embodiment, validating location information can comprise receiving registration information from a subscriber of a communication service. The registration information can comprise a telephone number and an address. For example, the received address can comprise a United States Postal Service (USPS) standard address. In some cases, the validated address can comprise a Master Street Address Guide (MSAG) valid address. A set of latitude-longitude coordinates can be obtained for the received address and the received address can be validated using the obtained set of latitude and longitude coordinates and a set of community definitions. For example, the set of community definitions can comprise a set of latitude and longitude coordinates identifying boundaries of one or more communities.

According to one embodiment, validating the received address using the obtained set of latitude and longitude coordinates and the set of community definitions can comprise comparing the latitude and longitude coordinates of the received address to the set of latitude and longitude coordinates identifying boundaries of one or more communities. In response to finding the latitude and longitude coordinates of the received address to be within the set of latitude and longitude coordinates identifying boundaries of matching one of the one or more communities, a community property of the validated address can be updated or set to a name of the matching one of the one or more communities. In some cases, the updated address can be provided for verification or correction, for example by a human reviewer, and a determination can be made as to whether the updated address has been validated based on that review. In response to determining the updated address has been validated, the validated address can be considered verified.

According to one embodiment, in response to not finding the latitude and longitude coordinates of the received address to be within the set of latitude and longitude coordinates identifying boundaries of matching one of the one or more communities or determining the updated address has not been validated, a further determination can be made as to whether defined boundaries of the one or more communities remain to be checked. In response to determining defined boundaries of the one or more communities remain to be checked validating the received address using the obtained set of latitude and longitude coordinates and the set of community definitions can be repeated until the received address is successfully validated or a determination is made that no defined boundaries of the one or more communities remain to be checked. In response determining that no defined boundaries of the one or more communities remain to be checked, the received address can be provided for correction, for example provided to a human reviewer for manual correction. A correction of the received address can be received which can include at least an indication of a community. A community property of the validated address can be defined based on the received correction and the validated address can be considered to be verified.

Once validated, the received telephone number and validated address can be stored in a record of a set of registration data and the validated address with the obtained latitude and longitude can be assigned to a community of the set of community definitions. The set of latitude and longitude coordinates identifying boundaries of the one or more communities in the set of community definitions can be updated based on validated addresses assigned to the one or more communities. For example, updating the set of latitude and longitude coordinates identifying boundaries of the one or more communities in the set of community definitions based on validated addresses assigned to the one or more communities comprises applying an algorithm such ad a convex-hull algorithm, a concave-hull algorithm, or other similar algorithm to the latitude and longitude coordinates of all validated addresses assigned to each of the one or more communities.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating elements of an exemplary environment in which validation of location information may be performed and in which embodiments of the present invention may be implemented.

FIG. 4 illustrates conceptually a mapping of registered addresses to a defined community for use in validation of location information according to one embodiment of the present invention.

FIG. 5 is a flowchart illustrating an exemplary process for validation of location information according to one embodiment of the present invention.

FIG. 6 is a flowchart illustrating additional details of a process for validation of location information according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

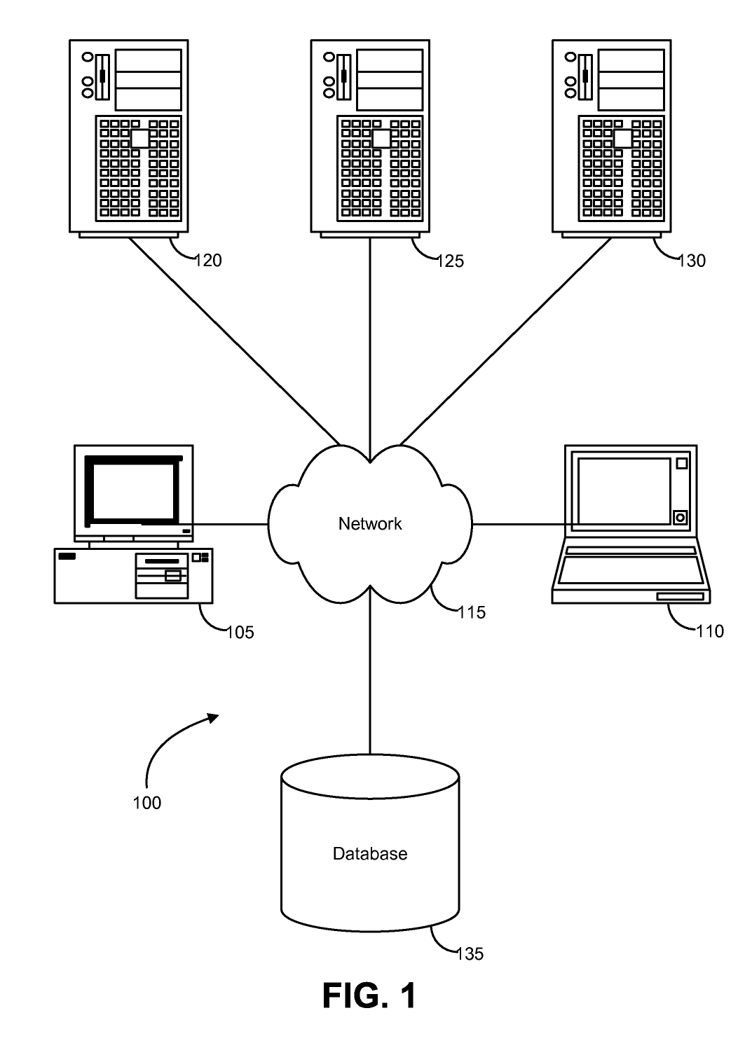

FIG. 1 is a system block diagram illustrating components of an exemplary operating environment in which various embodiments of the present invention may be implemented. The system 100 may include one or more user computers 105a-b which may be used to operate a client, whether a dedicated application, web browser, etc. The user computers 105a-b may be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, a variety of GNU/Linux operating systems). These user computers 105, 110 may also have any of a variety of applications, including one or more development systems, database client and/or server applications, and web browser applications. Alternatively, the user computers 105a-b may be any other electronic device, such as a thin-client computer, Internet-enabled mobile telephone, and/or personal digital assistant (PDA), capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network 115 may be any type of network familiar to those skilled in the art that may support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5G, CDMA, CDMA2000, WCDMA, EVDO etc.

The system 100 may also include one or more server computers 120a-c which may be general purpose computers and/or specialized server computers (including, merely by way of example, PC servers, UNIX servers, mid-range servers, mainframe computers rack-mounted servers, etc.). One or more of the servers (e.g., 120) may be dedicated to running applications, such as a business application, a web server, application server, etc. Such servers 120 may be used to process requests from user computers 105. The applications may also include any number of applications for controlling access to resources of the servers 120.

A web server may run an operating system including any of those discussed above, as well as any commercially-available server operating systems. The web server may also run any of a variety of server applications and/or mid-tier applications, including HTTP servers, FTP servers, CGI servers, database servers, Java servers, business applications, and the like. The server(s) 120 also may be one or more computers that may be capable of executing programs or scripts in response to the user computers 105, 110. As an example, a server 120 may execute one or more web applications. A web application may be implemented as one or more scripts or programs written in any programming language, such as Java™, C, C# or C++, and/or any scripting language, such as Perl, Python, or TCL, as well as combinations of any programming/scripting languages. The server(s) 120 may also include database servers, including without limitation those commercially available from Oracle®, Microsoft®, Sybase®, IBM® and the like, which may process requests from database clients running on a user computer 105.

In some embodiments, an application server may create web pages dynamically for displaying on an end-user (client) system. The web pages created by the web application server may be forwarded to a user computer 105 via a web server. Similarly, the web server may receive web page requests and/or input data from a user computer and may forward the web page requests and/or input data to an application and/or a database server. Those skilled in the art will recognize that the functions described with respect to various types of servers 120 may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105 or servers 120. Alternatively, it may be remote from any or all of the computers 105 or servers 120, and/or in communication (e.g., via the network 115) with one or more of these. In a particular set of embodiments, the database 135 may reside in a storage-area network (“SAN”) familiar to those skilled in the art. Similarly, any necessary files for performing the functions attributed to the computers 105 or servers 120 may be stored locally on the respective computer and/or remotely, as appropriate. In one set of embodiments, the database 135 may be a relational database, such as Oracle 10g, that is adapted to store, update, and retrieve data in response to SQL-formatted commands.

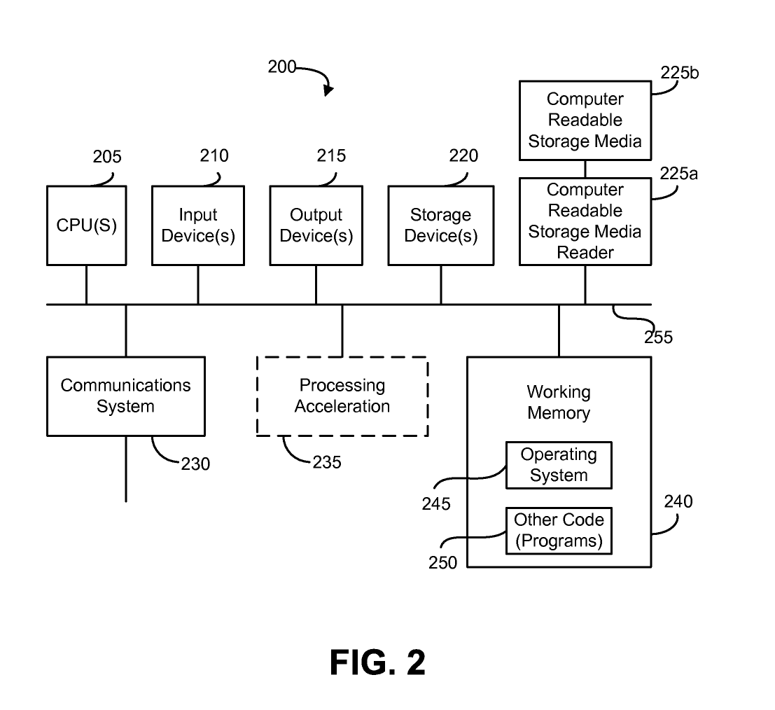

FIG. 2 illustrates an exemplary computer system 200, in which various embodiments of the present invention may be implemented. The computer system 200 may be used to implement any of the systems 100 described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage devices 220. By way of example, storage device(s) 220 may be disk drives, optical storage devices, solid-state storage device such as a random access memory (“RAM”) and/or a read-only memory (“ROM”), which may be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which may include a digital signal processor (DSP), a special-purpose processor and/or the like.

The computer-readable storage media reader 225a may further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 115 and/or any other computer 105 or server 120 described above with respect to the system 100.

The computer system 200 may also comprise software elements, shown as being currently located within working memory 240, including an operating system 245 and/or other code 250, such as an application program (which may be a client application, web browser, mid-tier application, RDBMS, etc.). It should be appreciated that alternate embodiments of computer system 200 may have numerous variations from that described above. For example, customized hardware may also be used and/or particular elements may be implemented in hardware, software (including portable software, such as applets), or both. Further, connection to other computing devices such as network input/output devices may be employed. Software of computer system 200 may include code 250 for implementing embodiments of the present invention as described herein.

For example, any of the networks, servers, and/or computer described above may be utilized to implement embodiments of the present invention. Generally speaking, embodiments of the present invention can include a validation process for location information received during registration of a subscriber of a communication service. The registration information can comprise a telephone number and an address. In one example, the received address can comprise a United States Postal Service (USPS) standard address while the validated address can comprise a Master Street Address Guide (MSAG) valid address. However, other formats and/or standards are contemplated and considered to be within the scope of the present invention.

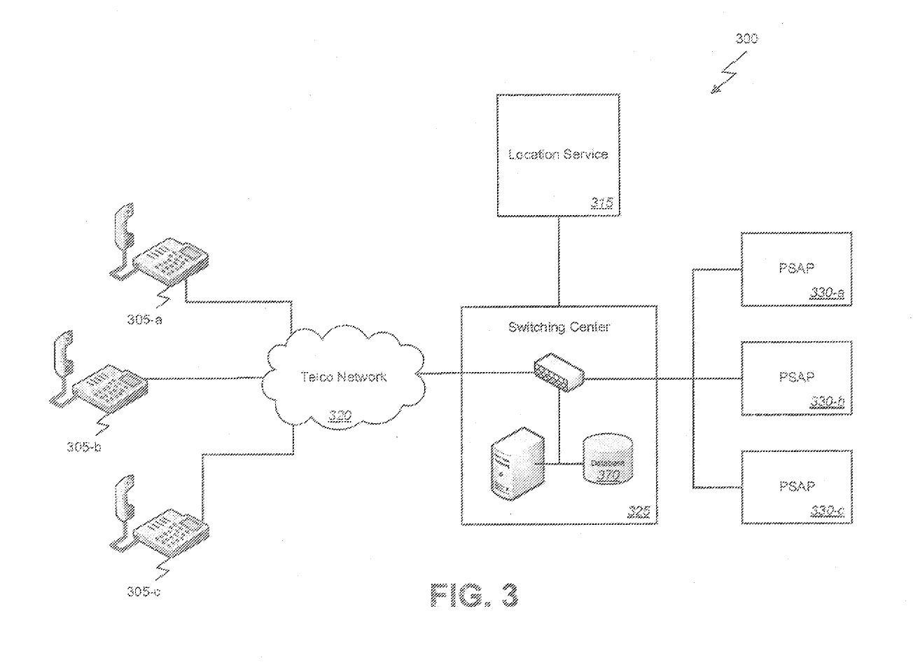

FIG. 3 is a block diagram illustrating elements of an exemplary environment in which validation of location information may be performed and in which embodiments of the present invention may be implemented. As illustrated here, the system 300 may include a number of telephones 305a-c of various types, each associated with a different telephone number. These telephones 305a-c may be communicatively coupled with a telephone network 320 sending and receiving calls, including but not limited to emergency calls, e.g., 911 calls. For example, the system 300 may also include a switching center 325 that may also be communicatively coupled with the telephone network 320. As known in the art, the switching center 325 may receive and route calls and other communications to and from telephones 305. In the case of an emergency call, the switching center 325 may determine which of any number of Public Safety Answering Points (PSAPs) 330a-c the call should be routed to based, for example, on the location of the caller and a defined geographic area for which the PSAP 330 is responsible. Generally speaking, this routing can be based on a set of information maintained in a database 370, e.g., an Automatic Location Identification (ALI) database, within the switching center 325 or elsewhere and accessible by the switching center 325. This set of information can include an indication of an address associated with each of a set of telephone numbers. Generally, this information will be collected and set during a registration process between an owner of the telephone 305 and the operator of the switching center 325. Once registered and this information is saved, the database 370 may be referenced by the switching center 325 when routing an emergency call from the registered telephone 305 to one of the PSAPs 330 as known in the art.

According to one embodiment, the registration of a telephone number and associated address in the database 370 can include a validation process. For example, the address received during registration can comprise a United States Postal Service (USPS) standard address. However, the switching center 325 and PSAPs 330 may utilize Master Street Address Guide (MSAG) valid address. Therefore, the switching center 325 may implement a validation process as described herein to confirm that the received address is appropriate and in the valid format or convert the received address as needed.

Accordingly, the switching center 325 can obtain, for example from a third-party location service 315, latitude and longitude coordinates for each address received during registration. A MSAG community name can be determined by the switching center 325 during the validation process as will be described, and a set of location within a particular community can be identified in terms of the latitude and longitude associated with each received and validated address and can also be saved in the database 370. Periodically, on request, or upon the occurrence of some event, these accumulated definitions can be used to determine boundaries for a particular MSAG community. For example, an algorithm such as the convex-hull algorithm can be applied to the saved coordinates for each previously validated address. The convex hull algorithm is a spatial algorithm that defines a boundary around a set of points based on the outermost points of the set, thereby defining a polygon that is a known likely outermost boundary of the set of points, in this case the locations that make up an MSAG community. Note that this is unlikely to be the actual geographic boundary of the MSAG community, but defines a likely community for addresses that fall within the convex hull. It should also be noted that in other implementations other algorithms may be used without departing from the scope of the present invention. For example, in some implementations the concave-hull algorithm may be suitable or more effective.

Subsequently, when validating an address, i.e., attempting to match the postal city to the MSAG community, the switching center 325 can compare the coordinates of the postal city to the set of MSAG community boundaries using the point-in-poly method. If the coordinates fall within one of the MSAG boundaries, that community name can be used for the MSAG validation. As the registered address density increases in a given location, and more matches are made, the outline of the convex hull will more closely match the actual community boundary.

Stated another way, validating location information can begin with the switching center 325 receiving registration information from a subscriber of a communication service. The registration information can comprise a telephone number and an address. In one example, the received address can comprise a USPS standard address. However, other formats and/or standards are contemplated and considered to be within the scope of the present invention. A set of latitude-longitude coordinates for the received address can also be obtained by the switching center 325 from a location service 315.

The received address can then be validated by the switching center 325 using the obtained set of latitude and longitude coordinates and a set of community definitions. The set of community definitions can comprise a set of latitude and longitude coordinates identifying boundaries of one or more communities. Generally speaking, validating the received address can include determining whether the received address falls within the defined boundaries of one of the communities in the community definitions and setting a community property of the validated address accordingly. According to one embodiment, the validated address can comprise a MSAG valid address. However, other formats and/or standards are contemplated and considered to be within the scope of the present invention.

More specifically, validating the received address using the obtained set of latitude and longitude coordinates and the set of community definitions can comprise, in some cases, the switching center 325 comparing the received address to a list of valid address ranges. In response to failing to find a match for the received address in the list of valid address ranges, correction of address parameters of the received address can be attempted by the switching center 325, e.g., by adjusting a format of the received address based on comparing the received address to the list of valid address ranges. So for example, the received address may be 115 Elm Street, San Pedro, Calif. and the corresponding valid address range may be 100 to 200 ELM ST, SAN PEDRO, Calif. In such a case, the resulting validated address can be 115 ELM ST, SAN PEDRO, Calif.

Additionally or alternatively, the switching center 325 can compare the latitude and longitude coordinates of the received address to the set of latitude and longitude coordinates identifying boundaries of one or more communities. In response to finding the latitude and longitude coordinates of the received address to be within the set of latitude and longitude coordinates identifying boundaries of matching one of the one or more communities, a community property of the validated address can be defined or set to a name matching one of the one or more communities. In some cases, the validated address can be provided by the switching center 325 for verification or correction, for example by a human reviewer. In such cases, a verification or correction of the validated address can be received by the switching center 325 and the validated address may be updated accordingly.

In response to not finding the latitude and longitude coordinates of the received address to be within the set of latitude and longitude coordinates identifying boundaries of matching one of the one or more communities, the received address can be provided by the switching center 325 for correction, e.g., by a human reviewer. In such cases, a correction of the received address can be received by the switching center 325. The correction can include at least an indication of a community. A community property of the validated address can then be defined or set by the switching center 325 based on the received correction.

Once validated, the received telephone number and validated address can be stored in a record of a set of registration data in the database 370 by the switching center 325. For example, the database 370 might comprise an ALI database as described above. Additionally, the validated address with the obtained latitude and longitude can be assigned to a community of the set of community definitions. That is, the community definitions can be continually updated by the switching center 325 with results of each validation, thus expanding and training the community definitions and validation process. Furthermore, the set of latitude and longitude coordinates identifying boundaries of the one or more communities in the set of community definitions of the database 370 can be updated by the switching center 325 based on validated addresses assigned to the one or more communities. For example, updating the set of latitude and longitude coordinates identifying boundaries of the one or more communities in the set of community definitions based on validated addresses assigned to the one or more communities can comprise applying a convex-hull algorithm to the latitude and longitude coordinates of all validated addresses assigned to each of the one or more communities. In another example, updating the set of latitude and longitude coordinates identifying boundaries of the one or more communities in the set of community definitions based on validated addresses assigned to the one or more communities can comprise applying a concave-hull algorithm to the latitude and longitude coordinates of all validated addresses assigned to each of the one or more communities. As noted, other algorithms are contemplated and considered to be within the scope of the present invention.

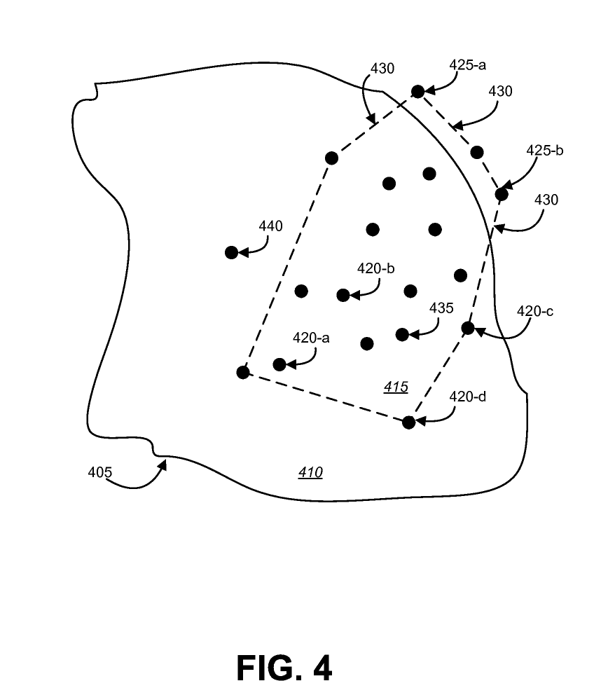

FIG. 4 illustrates conceptually a mapping of registered addresses to a defined community for use in validation of location information according to one embodiment of the present invention. As illustrated in this example, a geographic boundary 405 defines an MSAG community 410. Also illustrated here are registered and validated addresses 420 and 425 that have previously been assigned to the MSAG community 410 during previous validation processes. It may be noted that some of these addresses 420 fall within the geographic boundary 405 of the MSAG community 410 while some fall outside of the geographic boundary 405 yet are still assigned to the MSAG community during validation. Also illustrated here is a generated or determined boundary 430 for the validated addresses. As noted above, this boundary 430 can be determined by applying an algorithm such as the convex-hull algorithm, the concave-hull algorithm, or another algorithm to the latitude and longitude coordinates of each validated address 420 and 425 assigned to the MSAG community.

As a new address 435 is registered, the latitude and longitude coordinates of the address 435 can be compared to the generated boundaries 430, e.g., using a point-in-poly comparison, to determine if the address is within the MSAG community 435 and thus should be validated as such. Similarly, as a new address 440 is added and validated as being part of the MSAG community 410, even if it falls outside of the generated boundaries 430, that location can be used to redefine or update the generated boundaries. So for example, the convex-hull, concave-hull, or other algorithm can be reapplied periodically, upon demand, upon the occurrence of some event, or under some other conditions, and including all previous addresses 420 and 425 as well as newly added addresses 435 and 440. It may be noted that this generated boundary 430 does not match the geographic boundary 405 but it does encompass all addresses 420 and 425 assigned to the MSAG community 410. Furthermore, with time and as validated addresses 435 and 440 are added to the MSAG community 410, the generated boundaries 430 can be updated and will eventually more closely approximate the geographic boundary 405.

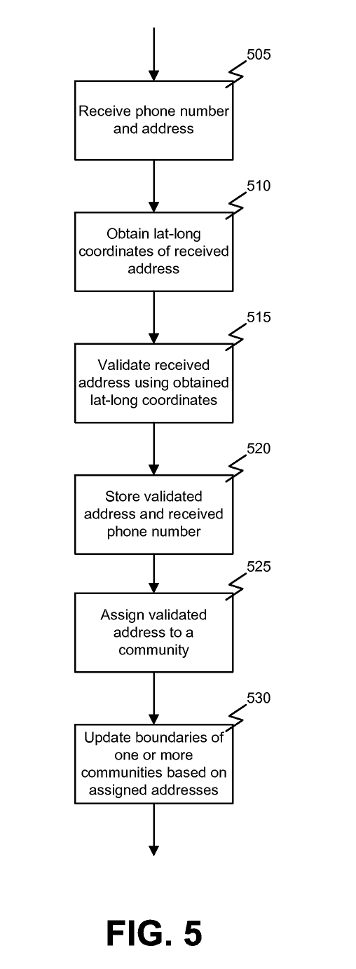

FIG. 5 is a flowchart illustrating an exemplary process for validation of location information according to one embodiment of the present invention. As illustrated in this example, validating location information can begin with receiving 505 registration information from a subscriber of a communication service. The registration information can comprise a telephone number and an address. In one example and as described above, the received address can comprise a United States Postal Service (USPS) standard address. However, other formats and/or standards are contemplated and considered to be within the scope of the present invention. A set of latitude-longitude coordinates can also be obtained 510 for the received address.

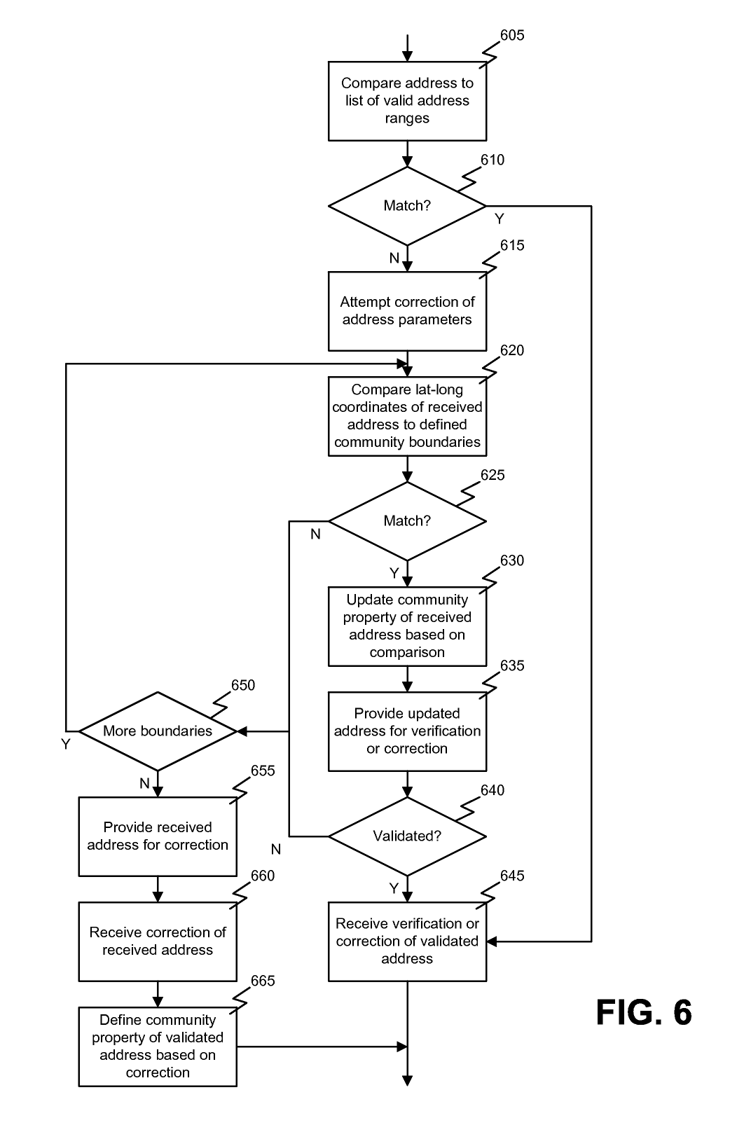

The received address can then be validated 515 using the obtained set of latitude and longitude coordinates and a set of community definitions. The set of community definitions can comprise a set of latitude and longitude coordinates identifying boundaries of one or more communities. As will be described in greater detail with reference to FIG. 6, validating 515 the received address can include determining whether the received address falls within the defined boundaries of one of the communities in the community definitions and setting a community property of the validated address accordingly. According to one embodiment, the validated address can comprise a Master Street Address Guide (MSAG) valid address. However, other formats and/or standards are contemplated and considered to be within the scope of the present invention.

Once validated 515, the received telephone number and validated address can be stored 520 in a record of a set of registration data. For example, the registration data might comprise an ALI database as described above. Additionally, the validated address with the obtained latitude and longitude can be assigned 525 to a community of the set of community definitions. That is, the community definitions can be continually updated with results of each validation, thus expanding and training the community definitions and validation process. Furthermore, the set of latitude and longitude coordinates identifying boundaries of the one or more communities in the set of community definitions can be updated 530 based on validated addresses assigned 525 to the one or more communities. For example, updating 530 the set of latitude and longitude coordinates identifying boundaries of the one or more communities in the set of community definitions based on validated addresses assigned 525 to the one or more communities can comprise applying a convex-hull algorithm to the latitude and longitude coordinates of all validated addresses assigned 525 to each of the one or more communities. In another example, updating 530 the set of latitude and longitude coordinates identifying boundaries of the one or more communities in the set of community definitions based on validated addresses assigned 525 to the one or more communities can comprise applying a concave-hull algorithm to the latitude and longitude coordinates of all validated addresses assigned 525 to each of the one or more communities. As noted, other algorithms are contemplated and considered to be within the scope of the present invention.

FIG. 6 is a flowchart illustrating additional details of a process for validation of location information according to one embodiment of the present invention. As illustrated in this example, validating 515 the received address using the obtained set of latitude and longitude coordinates and the set of community definitions can comprise, in some cases, comparing 605 the received address to a list of valid address ranges. In response to failing to find 610 a match for the received address in the list of valid address ranges, correction of address parameters of the received address can be attempted 615, e.g., by adjusting a format of the received address based on comparing the received address to the list of valid address ranges.

Additionally or alternatively, validating 515 the received address using the obtained set of latitude and longitude coordinates and the set of community definitions can comprise comparing 620 the latitude and longitude coordinates of the received address to the set of latitude and longitude coordinates identifying boundaries of one or more communities. In response to finding 625 the latitude and longitude coordinates of the received address to be within the set of latitude and longitude coordinates identifying boundaries of matching one of the one or more communities, a community property of the validated address can be updated 630 or set to a name of the matching one of the one or more communities. In some cases, the updated address can be provided 635 for verification or correction, for example by a human reviewer, and a determination 640 can be made as to whether the updated address has been validated based on that review. In response to determining 640 the updated address has been validated, the validated address can be considered verified 645.

In response to not finding 625 the latitude and longitude coordinates of the received address to be within the set of latitude and longitude coordinates identifying boundaries of matching one of the one or more communities or determining 640 the updated address has not been validated, a further determination 650 can be made as to whether defined boundaries of the one or more communities remain to be checked. In response to determining 650 defined boundaries of the one or more communities remain to be checked validating 620-635 the received address using the obtained set of latitude and longitude coordinates and the set of community definitions can be repeated until the received address is successfully validated 640 or a determination 650 is made that no defined boundaries of the one or more communities remain to be checked. In response determining 650 that no defined boundaries of the one or more communities remain to be checked, the received address can be provided 655 for correction, for example provided to a human reviewer for manual correction. A correction of the received address can be received 660 which can include at least an indication of a community. A community property of the validated address can be defined 665 based on the received correction and the validated address can be considered to be verified 645.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method for validating location information, the method comprising:
receiving, during a registration process for each subscriber of a plurality of subscribers of a communication service, registration information from the subscriber of the communication service, the registration information comprising a telephone number and an address;
obtaining a set of latitude-longitude coordinates for each received address;
validating each received address using the obtained set of latitude and longitude coordinates and a set of community definitions, the set of community definitions comprising a set of latitude and longitude coordinates identifying boundaries of one or more communities; and
storing each received telephone number and validated address in a record of a set of registration data;
assigning each validated address with the obtained latitude and longitude to a community of the set of community definitions; and
updating the set of latitude and longitude coordinates identifying boundaries of the one or more communities in the set of community definitions based on the stored validated addresses of the subscribers of the communication service assigned to the one or more communities, wherein updating the set of latitude and longitude coordinates identifying boundaries of the one or more communities redefines the boundaries to include each of the received addresses.

2. (canceled)

3. The method of claim 1, wherein updating the set of latitude and longitude coordinates identifying boundaries of the one or more communities in the set of community definitions based on validated addresses assigned to the one or more communities comprises applying a convex-hull algorithm to the latitude and longitude coordinates of all validated addresses assigned to each of the one or more communities.

4. The method of claim 1, wherein updating the set of latitude and longitude coordinates identifying boundaries of the one or more communities in the set of community definitions based on validated addresses assigned to the one or more communities comprises applying a concave-hull algorithm to the latitude and longitude coordinates of all validated addresses assigned to each of the one or more communities.

5. The method of claim 1, wherein the received address comprises a United States Postal Service (USPS) standard address.

6. The method of claim 5, wherein the validated address comprises a Master Street Address Guide (MSAG) valid address.

7. The method of claim 1, wherein validating the received address using the obtained set of latitude and longitude coordinates and the set of community definitions comprises:
comparing the received address to a list of valid address ranges; and
in response to failing to find a match for the received address in the list of valid address ranges, adjusting a format of the received address based on comparing the received address to the list of valid address ranges.

8. The method of claim 1, wherein validating the received address using the obtained set of latitude and longitude coordinates and the set of community definitions comprises:
comparing the latitude and longitude coordinates of the received address to the set of latitude and longitude coordinates identifying boundaries of one or more communities;
in response to finding the latitude and longitude coordinates of the received address to be within the set of latitude and longitude coordinates identifying boundaries of matching one of the one or more communities, updating a community property of the received address to a name of the matching one of the one or more communities, providing the updated address for verification or correction, and determining whether the updated address has been validated; and
in response to determining the updated address has been validated, verifying the validated address.

9. The method of claim 8, further comprising, in response to not finding the latitude and longitude coordinates of the received address to be within the set of latitude and longitude coordinates identifying boundaries of matching one of the one or more communities or determining the updated address has not been validated:
further determining whether defined boundaries of the one or more communities remain to be checked; and
in response to determining defined boundaries of the one or more communities remain to be checked, repeating said validating the received address using the obtained set of latitude and longitude coordinates and the set of community definitions until the received address is successfully validated or no defined boundaries of the one or more communities remain to be checked.

10. The method of claim 9, further comprising, in response to not finding the latitude and longitude coordinates of the received address to be within the set of latitude and longitude coordinates identifying boundaries of matching one of the one or more communities or determining the updated address has not been validated and further determining that no defined boundaries of the one or more communities remain to be checked:
providing the received address for correction;
receiving a correction of the received address, the correction including at least an indication of a community;
defining a community property of the validated address based on the received correction; and
verifying the validated address.

11. A system comprising:
a processor; and
a memory coupled with and readable by the processor and storing therein a set of instructions which, when executed by the processor, causes the processor to validate location information by:
receiving, during a registration process for each subscriber of a plurality of subscribers of a communication service, registration information from the subscriber of the communication service the registration information comprising a telephone number and an address;
obtaining a set of latitude-longitude coordinates for each received address;
validating each received address using the obtained set of latitude and longitude coordinates and a set of community definitions, the set of community definitions comprising a set of latitude and longitude coordinates identifying boundaries of one or more communities; and
storing each received telephone number and validated address in a record of a set of registration data;
assigning each validated address with the obtained latitude and longitude to a community of the set of community definitions; and
updating the set of latitude and longitude coordinates identifying boundaries of the one or more communities in the set of community definitions based on the stored validated addresses of the subscribers of the communication service assigned to the one or more communities, wherein updating the set of latitude and longitude coordinates identifying boundaries of the one or more communities redefines the boundaries to include each of the received addresses.

12. (canceled)

13. The system of claim 11, wherein updating the set of latitude and longitude coordinates identifying boundaries of the one or more communities in the set of community definitions based on validated addresses assigned to the one or more communities comprises applying a convex-hull algorithm to the latitude and longitude coordinates of all validated addresses assigned to each of the one or more communities.

14. The system of claim 11, wherein updating the set of latitude and longitude coordinates identifying boundaries of the one or more communities in the set of community definitions based on validated addresses assigned to the one or more communities comprises applying a concave-hull algorithm to the latitude and longitude coordinates of all validated addresses assigned to each of the one or more communities.

15. The system of claim 11, wherein the received address comprises a United States Postal Service (USPS) standard address.

16. The system of claim 15, wherein the validated address comprises a Master Street Address Guide (MSAG) valid address.

17. The system of claim 11, wherein validating the received address using the obtained set of latitude and longitude coordinates and the set of community definitions comprises:
comparing the received address to a list of valid address ranges; and
in response to failing to find a match for the received address in the list of valid address ranges, adjusting a format of the received address based on comparing the received address to the list of valid address ranges.

18. The system of claim 11, wherein validating the received address using the obtained set of latitude and longitude coordinates and the set of community definitions comprises:
comparing the latitude and longitude coordinates of the received address to the set of latitude and longitude coordinates identifying boundaries of one or more communities;
in response to finding the latitude and longitude coordinates of the received address to be within the set of latitude and longitude coordinates identifying boundaries of matching one of the one or more communities, updating a community property of the received address to a name of the matching one of the one or more communities, providing the updated address for verification or correction, and determining whether the updated address has been validated; and
in response to determining the updated address has been validated, verifying the validated address.

19. The system of claim 18, further comprising, in response to not finding the latitude and longitude coordinates of the received address to be within the set of latitude and longitude coordinates identifying boundaries of matching one of the one or more communities or determining the updated address has not been validated:
further determining whether defined boundaries of the one or more communities remain to be checked; and
in response to determining defined boundaries of the one or more communities remain to be checked, repeating said validating the received address using the obtained set of latitude and longitude coordinates and the set of community definitions until the received address is successfully validated or no defined boundaries of the one or more communities remain to be checked.

20. The system of claim 19, further comprising, in response to not finding the latitude and longitude coordinates of the received address to be within the set of latitude and longitude coordinates identifying boundaries of matching one of the one or more communities or determining the updated address has not been validated and further determining that no defined boundaries of the one or more communities remain to be checked:
providing the received address for correction;
receiving a correction of the received address, the correction including at least an indication of a community;
defining a community property of the validated address based on the received correction; and
verifying the validated address.

21. A computer-readable memory device comprising a set of instructions stored therein which, when executed by a processor, causes the processor to validate location information by:
receiving, during a registration process for each subscriber of a plurality of subscribers of a communication service, registration information from the subscriber of the communication service e, the registration information comprising a telephone number and an address;
obtaining a set of latitude-longitude coordinates for each received address;
validating each received address using the obtained set of latitude and longitude coordinates and a set of community definitions, the set of community definitions comprising a set of latitude and longitude coordinates identifying boundaries of one or more communities; and
storing each received telephone number and validated address in a record of a set of registration data;
assigning each validated address with the obtained latitude and longitude to a community of the set of community definitions; and
updating the set of latitude and longitude coordinates identifying boundaries of the one or more communities in the set of community definitions based on the stored validated addresses of the subscribers of the communication service assigned to the one or more communities, wherein updating the set of latitude and longitude coordinates identifying boundaries of the one or more communities redefines the boundaries to include each of the received addresses.

22. (canceled)

23. The computer-readable memory device of claim 21, wherein updating the set of latitude and longitude coordinates identifying boundaries of the one or more communities in the set of community definitions based on validated addresses assigned to the one or more communities comprises applying a convex-hull algorithm to the latitude and longitude coordinates of all validated addresses assigned to each of the one or more communities.

24. The computer-readable memory device of claim 21, wherein updating the set of latitude and longitude coordinates identifying boundaries of the one or more communities in the set of community definitions based on validated addresses assigned to the one or more communities comprises applying a concave-hull algorithm to the latitude and longitude coordinates of all validated addresses assigned to each of the one or more communities.

25. The computer-readable memory device of claim 21, wherein the received address comprises a United States Postal Service (USPS) standard address.

26. The computer-readable memory device of claim 25, wherein the validated address comprises a Master Street Address Guide (MSAG) valid address.

27. The computer-readable memory device of claim 21, wherein validating the received address using the obtained set of latitude and longitude coordinates and the set of community definitions comprises:
comparing the received address to a list of valid address ranges; and
in response to failing to find a match for the received address in the list of valid address ranges, adjusting a format of the received address based on comparing the received address to the list of valid address ranges.

28. The computer-readable memory device of claim 21, wherein validating the received address using the obtained set of latitude and longitude coordinates and the set of community definitions comprises:
comparing the latitude and longitude coordinates of the received address to the set of latitude and longitude coordinates identifying boundaries of one or more communities;
in response to finding the latitude and longitude coordinates of the received address to be within the set of latitude and longitude coordinates identifying boundaries of matching one of the one or more communities, updating a community property of the received address to a name of the matching one of the one or more communities, providing the updated address for verification or correction, and determining whether the updated address has been validated; and
in response to determining the updated address has been validated, verifying the validated address.

29. The computer-readable memory device of claim 28, further comprising, in response to not finding the latitude and longitude coordinates of the received address to be within the set of latitude and longitude coordinates identifying boundaries of matching one of the one or more communities or determining the updated address has not been validated:
further determining whether defined boundaries of the one or more communities remain to be checked; and
in response to determining defined boundaries of the one or more communities remain to be checked, repeating said validating the received address using the obtained set of latitude and longitude coordinates and the set of community definitions until the received address is successfully validated or no defined boundaries of the one or more communities remain to be checked.

30. The computer-readable memory device of claim 29, further comprising, in response to not finding the latitude and longitude coordinates of the received address to be within the set of latitude and longitude coordinates identifying boundaries of matching one of the one or more communities or determining the updated address has not been validated and further determining that no defined boundaries of the one or more communities remain to be checked:
providing the received address for correction;
receiving a correction of the received address, the correction including at least an indication of a community;
defining a community property of the validated address based on the received correction; and
verifying the validated address.
